(19) United States
(12) Patent Application Publication
(10) Pub. No.: US 2009/0227792 A1
(43) Pub. Date: Sep. 10, 2009

(54) HIGHLY REACTIVE a-AMINOMETHYL-ALKOXYSILANES HAVING IMPROVED STABILITY

(75) Inventors: Christoph Briehn, Munich (DE); Volker Stanjek, Munich (DE); Richard Weidner, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/720,891

(22) PCT Filed: Nov. 17, 2005
(86) PCT No.: PCT/EP2005/012337

§ 371 Date: Jun. 5, 2007

(30) Foreign Application Priority Data
Dec. 9, 2004 (DE) 10 2004 059 378.7

(51) Int. Cl. C07F 7/10

(52) U.S. Cl. 544/229; 548/110

(57) ABSTRACT

α-aminoalkoxysilanes wherein the α-amino group is a tertiary amino group, and which also contains a further reactive group, display excellent reactivity of the alkoxy groups while remaining stable with respect to decomposition and byproduct formation, particularly through cleavage of the Si-C bond. The α-aminosilanes are particularly useful for preparing alkoxysilyl-terminated prepolymers which exhibit high cure rates in the presence of moisture, and for functionalizing particles reactive therewith.

The invention relates to aminomethyl-functional alkoxysilanes and to their use.

Organofunctional alkoxysilanes are used in a wide variety of sectors. They may serve, for instance, as coupling agents in organic-inorganic composite systems. They are used for preparing hybrid materials containing organic and inorganic and/or silicone-containing structural elements. Furthermore, they are used to provide (nano)particles with organic functions allowing them to be incorporated, say, into an organic matrix. A further very important application is the preparation of prepolymers which cure on contact with (atmospheric) moisture to form solid compositions.

Prepolymer systems of this kind possessing reactive alkoxysilyl groups have been known for a long time and are widely used for the production of elastic sealants and adhesives in the industrial and construction sectors. In the presence of atmospheric moisture and appropriate catalysts, these alkoxysilane-terminated prepolymers are capable even at room temperature of undergoing condensation with one another, accompanied by elimination of the alkoxy groups and the formation of Si—O—Si bonds. These prepolymers can therefore be used as, among other things one-component, air-curing systems, which possess the advantage of ease of handling, since there is no need to meter out and mix in a second component.

A further advantage of alkoxysilane-terminated prepolymers lies in the fact that the curing is accompanied by release neither of acids nor of oximes or amines. In contrast to the case with isocyanate-based adhesives or sealants, no CO₂ is formed either, which as a gaseous component can lead to blistering. In contrast to isocyanate-based systems, alkoxysilane-terminated prepolymer mixtures are also toxicologically unobjectionable.

Depending on the amount of alkoxysilane groups and on their construction, the principal products of the curing of this type of prepolymer are long-chain polymers (thermoplastics), relatively wide-meshed three-dimensional networks (elastomers) or else highly crosslinked systems (thermosets).

Alkoxysilane-functional prepolymers can be constructed from various units. They typically possess an organic backbone; that is, they are constructed, for example from polyurethanes, polyethers, polyesters, polyacrylates, polyvinyl esters, ethylene-olefin copolymers, styrene-butadiene copolymers or polyolefins, as described inter alia in U.S. Pat. No. 6,207,766 and U.S. Pat. No. 3,971,751. Also widely spread, however, are systems whose backbone is composed wholly or at least partly of organosiloxanes, as described inter alia in U.S. Pat. No. 5,254,657.

Of central importance to prepolymer preparation, however, are the monomeric alkoxysilanes via which the prepolymer is furnished with the necessary alkoxysilane functions. In this context it is possible in principle to employ any of a very wide variety of silanes and coupling reactions, as for example an addition reaction of Si—H-functional alkoxysilanes on unsaturated prepolymers or a copolymerization of unsaturated organosilanes with other unsaturated monomers. Likewise conceivable are nucleophilic addition or substitution reactions on alkoxysilanes which possess a carbonyl function.

In another process, alkoxysilane-terminated prepolymers are prepared by reaction of OH-functional prepolymers with isocyanate-functional alkoxysilanes. Systems of this kind are described for example in U.S. Pat. No. 5,068,304. The resulting prepolymers often feature particularly positive properties, such as very good mechanical properties on the part of the cured compositions, for example. Disadvantageous, however, is the complicated and costly preparation of the isocyanate-functional silanes, and the fact that from a toxicological standpoint these silanes are extremely objectionable.

Often more favorable in this context is a preparation process for alkoxysilane-terminated prepolymers that starts from polyols, such as from polyether- or polyester polyols. In a first reaction step these polyols react with an excess of a di- or polyisocyanate. Subsequently the isocyanate-terminated prepolymers obtained in the first step are reacted with an amino-functional alkoxysilane to give the desired alkoxysilane-terminated prepolymer. Systems of this kind are described for example in EP 1 256 595 or EP 1 245 601. The advantages of these systems lie above all in the particularly positive properties of the resulting prepolymers. They are usually notable, for example, for high tensile strength on the part of the cured compositions, which is attributable—at least in part—to the urethane and urea units that are present in these polymers and to their capacity to form hydrogen bonds. A further advantage of these prepolymer systems is represented by the fact that the amino-functional silanes needed as reactants are available through simple and inexpensive processes and from a toxicological standpoint are largely unobjectionable.

A disadvantage of the majority of known systems used at present, however, is their no more than moderate reactivity with respect to moisture, either in the form of atmospheric humidity or in the form of existing or added water. In order to achieve a sufficient cure rate at room temperature it is therefore vital to add a catalyst. The principal reason why this presents problems is that the organotin compounds generally employed as catalysts are toxicologically objectionable. Moreover, the tin catalysts often also still contain traces of highly toxic tributyltin derivatives.

A particular problem is the relatively low reactivity of the alkoxysilyl-functional prepolymer systems if, rather than methoxysilyl groups, the even less reactive ethoxysilyl groups are used. Ethoxysilyl-functional prepolymers specifically, however, would be particularly advantageous in many cases, since their curing is accompanied by the release only of ethanol as a cleavage product.

In order to avoid problems with toxic tin catalysts, attempts have already been made to look for tin-free catalysts. Consideration may be given here, in particular, to titanium catalysts, such as titanium tetraisopropoxide or bis(acetylacetonato)diisobutyl titanate, which are described for example in EP 885 933 A. These titanium catalysts, though, possess the disadvantage that they cannot usually be used in combination with nitrogen compounds, since the latter compounds act here as catalyst poisons. The use of nitrogen compounds, as adhesion promoters for example, is unavoidable in many cases, however. Moreover, nitrogen compounds, aminosilanes for example, serve in many cases as reactants in the preparation of the silane-terminated prepolymers, and so are also present as barely avoidable impurities in prepolymers themselves.

A great advantage may therefore be represented by alkoxysilane-terminated prepolymer systems of the kind described for example in DE 101 42 050 A or DE 101 39 132 A. A feature of these prepolymers is that they contain alkoxysilyl groups separated only by a methyl spacer from a nitrogen atom having a free electron pair. This gives these prepolymers an extremely high reactivity toward (atmospheric) moisture, and so they can be processed to prepolymer blends which can manage without metal catalysts and yet cure at room temperature with short tack-free times, in some cases extremely short, and/or at a very high rate. Since these prepolymers thus possess an amine function in the position α to the silyl group, they are also referred to as α-alkoxysilane-terminated prepolymers.

These α-alkoxysilane-terminated prepolymers are typically prepared by the reaction of an α-aminosilane, i.e., of an aminomethyl-functional alkoxysilane, with an isocyanate-functional prepolymer or with an isocyanate-functional precursor of the prepolymer.

Common examples of α-aminosilanes are N-cyclohexylaminomethyltrimethoxysilane, N-cyclohexylaminomethylmethyldimethoxysilane, N-ethylaminomethyltrimethoxysilane, N-ethylaminomethylmethyldimethoxysilane, N-butylaminomethyltrimethoxysilane, N-cyclohexylaminomethyltriethoxysilane, N-cyclohexylaminomethylmethyldiethoxysilane, etc.

A critical disadvantage of these α-alkoxysilane-functional prepolymer systems, however, is the no more than moderate stability of the α-aminosilanes that are needed for their synthesis. Thus the Si—C bond, in particular, of these silanes can be cleaved easily, in some cases very easily. Comparable stability problems are unknown for the conventional γ-aminopropyl-alkoxysilanes.

This instability on the part of the α-aminosilanes is manifested with particular clarity in the presence of alcohol or water. For example, aminomethyltri-methoxysilane in the presence of methanol is broken down quantitatively into tetramethoxysilane within a few hours. With water it reacts to give tetrahydroxysilane and/or higher condensation products of said silane. Correspondingly, aminomethylmethyl-dimethoxysilane reacts with methanol to give methyltrimethoxysilane and with water to give methyltrihydroxysilane and/or higher condensation products of said silane. Somewhat more stable are N-substituted α-aminosilanes, e.g., N-cyclohexylaminomethylmethyldimethoxysilane or N-cyclohexylaminomethyltrimethoxysilane. Yet in the presence of traces of catalysts or of acidic and also basic impurities, even these silanes are broken down quantitatively within a few hours by methanol, to form N-methylcyclohexylamine and methyltrimethoxysilane and/or tetramethoxysilane. With water they react to form N-methylcyclohexylamine and methyltrihydroxysilane and/or tetrahydroxysilane or the more highly condensed homologs of these silanes. The majority of other N-substituted α-aminosilanes with a secondary nitrogen atom, as well, corresponding to the prior art, display the same breakdown reaction.

Even in the absence of methanol or water, however, these α-aminosilanes are of only moderate stability. Thus, particularly at elevated temperatures and in the presence of catalysts or catalytically active impurities, there may likewise be decomposition of the α-silanes with cleavage of the Si—C bond.

One of the reasons why the merely moderate stability of the α-aminosilanes is highly disadvantageous is usually that these silanes may undergo at least partial decomposition even under the reaction conditions of the prepolymer synthesis. This not only hinders the prepolymer synthesis but also leads in general to a deterioration in the polymer properties, in some cases massively so, since that synthesis also forms prepolymers which have been terminated not with the aminosilanes but instead by their decomposition products.

The only α-aminosilanes that are somewhat more stable are those with a secondary nitrogen atom that carry on the nitrogen atom an electron-withdrawing substituent, such as, for example, N-phenylaminomethyltrimethoxysilane or O-methylcarbamatomethyltrimethoxysilane. The amino functions of these silanes, however, are also much less reactive toward isocyanate groups, which is the reason they are generally unsuited to the preparation of silane-terminated prepolymers from isocyanate-functional precursors. For instance, the aforementioned O-methylcarbamatomethyltrimethoxysilane is so tardy to react that, even after several hours of boiling of this silane with a prepolymer possessing aliphatic isocyanate groups, it is virtually impossible to detect any reaction. Even catalysts such as dibutyltin dilaurate do not lead to any significant improvement in this situation. Only the N-phenyl-substituted silanes such as N-phenylaminomethyltrimethoxysilane possess a certain (albeit often still inadequate) reactivity toward isocyanate functions. They do react, however, to form aromatically substituted urea units, which can undergo photo-Fries rearrangements and hence are extremely UV-labile. The corresponding products, consequently, are completely unsuitable for the great majority of applications.

In E. Lukevics, E. P. Popova, Latv. PSR Zinat. Akad. Vestis, Kim. Ser. 1978, (2), 207-11 a piperazinosilane is described of the formula [1].

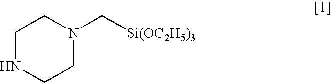

In that reference, however, only spectroscopic and toxicological data of this compound are described. Thus in that publication there are no indications at all that α-piperazinomethylalkoxysilanes such as the compound [1] possess the high reactivity typical of α-aminomethylalkoxysilanes and yet at the same time are distinguished by a significantly improved stability.

Further, piperazinosilanes are also specified in numerous other references, such as in EP 0 441 530. There, however, the description is exclusively of conventional γ-silanes whose alkoxysilyl group is separated by a propyl spacer from the piperazine ring. These compounds, like all γ-aminopropylsilanes, are indeed of relative stability, but possess only the typical, very moderate reactivity toward (atmospheric) moisture.

The object was therefore to provide α-aminomethyl-functional alkoxysilanes having a high reactivity toward (atmospheric) moisture which on the one hand are notable for improved stability but on the other hand possess a reactive function as well that allows them to be attached to an organic system, preferably to an organic prepolymer.

The invention provides alkoxysilanes (A) which possess at least one structural element of the general formula [2]

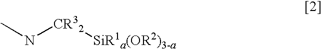

where
R¹ is an optionally substituted hydrocarbon radical or an ═N—CR³₂— group,
R² is an alkyl radical having 1-6 carbon atoms or an ω-oxaalkyl-alkyl radical having a total of 2-10 carbon atoms,
R³ is hydrogen or an optionally substituted hydrocarbon radical, and
a can adopt the values 0, 1, 2 or 3,
   with the proviso that the nitrogen atom in the general formula [2] is a tertiary nitrogen atom, and that the alkoxysilane (A) possesses at least one further reactive function (F) via which it can be attached to an organic co-reactant,
   the silane of the formula [1]

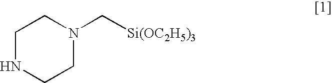

being excluded.

The invention is based on the revelation that α-aminomethylsilanes which in the position α to the silyl group possess a tertiary nitrogen atom are completely stable to (atmospheric) moisture in respect of Si—C bond cleavage. However, conventional α-aminosilanes with a tertiary nitrogen atom, such as N,N-diethylaminomethyltrimethoxysilane, N,N-dibutyl-aminomethyltrimethoxysilane, N,N-diethylaminomethyltriethoxysilane, N,N-dibutylaminomethyltriethoxysilane, etc., which on account of the absent reactive function (F) cannot be used for numerous reactions, cannot, for example, be processed with isocyanate-functional precursors to give α-alkoxysilane-functional pre-polymers.

The α-aminosilanes (A) of the invention are significantly more stable than conventional α-aminosilanes having a primary or secondary amino function in the position α to the silyl group. Thus, for example, the inventive silanes N-(methyldiethoxysilylmethyl)piperazine, N-(methyldimethoxysilylmethyl)-piperazine or N-(trimethoxysilylmethyl)piperazine are stable for several weeks even in methanolic solution (at 10% by weight).

Under the same conditions, conventional, noninventive aminomethyl-functional alkoxysilanes with a primary or secondary amine function have largely undergone decomposition after just a short time. Listed below are some typical half-lives of conventional α-aminosilanes:

Aminomethylmethyldimethoxysilane: t_{1/2}=6 h
Cyclohexylaminomethylmethyldimethoxysilane: t_{1/2}=1 week
Aminomethyltrimethoxysilane: t_{1/2}=19 h
Cyclohexylaminomethyltrimethoxysilane: t_{1/2}=3 days
Isobutylaminomethyltrimethoxysilane: t_{1/2}=1 week

The decomposition of the α-aminomethylsilanes here was detected by NMR spectroscopy.

The radicals R¹ have preferably 1 to 12, in particular 1 to 6, C atoms. They are preferably alkyl, cycloalkyl, aryl or arylalkyl radicals. Preferred radicals R¹ are methyl, ethyl or phenyl groups, the methyl group being particularly preferred. The radicals R² are preferably methyl or ethyl groups. The radicals R³ are preferably hydrogen or an optionally chlorine- or fluorine-substituted hydrocarbon radical having 1 to 6 C atoms, in particular hydrogen. a preferably adopts the values 0, 1 or 2.

In one preferred embodiment of the invention the reactive function (F) of the silanes (A) is a carboxyl or carbonyl group, more preferably an aldehyde or ketone group.

In one further preferred embodiment of the invention the reactive function (F) of the silanes (A) is an NH, OH or SH function, more preferably an NH function. These functions are reactive toward isocyanates.

Preferred alkoxysilanes (A) are those of the general formulae [3] and [4]

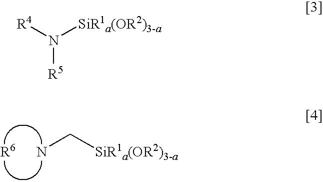

where
R⁴ is an optionally substituted alkyl, aryl or arylalkyl radical which possesses at least one carboxyl group, carbonyl group or one isocyanate-reactive OH, SH or NHR⁷ group, it being possible for the alkyl chain to be interrupted optionally by oxygen, carbonyl groups, sulfur or NR⁷ groups,
R⁵ is an optionally substituted alkyl, aryl or arylalkyl radical, it being possible for the alkyl chain to be interrupted optionally by oxygen, carbonyl groups, sulfur or NR⁷ groups, or is a radical R⁴,
R⁶ is a difunctional, optionally substituted alkyl or arylalkyl radical, which either possesses, in the alkyl chain, carbonyl group or an isocyanate-reactive NH function or an NR⁴ function or is substituted by at least one isocyanate-reactive OH, SH or NHR⁷ group, it being possible for the alkyl chain to be interrupted optionally by oxygen, sulfur, NR⁷ groups or carbonyl groups,
R⁷ is hydrogen or an optionally substituted alkyl, aryl or arylalkyl radical,
   and R¹, R² and a are as defined for the general formula [2].

The alkyl radicals R⁴ may be branched, unbranched or cyclic. Preference is given to alkyl radicals having 2-10 carbon atoms and possessing an OH function or monoalkylamino group, monoalkylamino groups being particularly preferred. The alkyl radicals R⁵ may be branched or unbranched. Preferred radicals R⁵ are alkyl groups having 1-6 carbon atoms. The alkyl or arylalkyl radicals R⁶ may be branched or unbranched. Preferred alkyl radicals R⁶ are difunctional alkyl radicals having 2-10 carbon atoms that possess, in the alkyl chain, a carbonyl or NH function. The alkyl or arylalkyl radicals R⁷ may be branched or unbranched. Preferred radicals R⁷ are hydrogen and alkyl groups having 1-6 carbon atoms.

Preference is also given to alkoxysilanes (A) of the general formula [5]

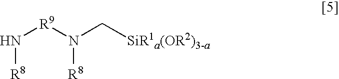

where
R⁸ is alkyl radical having 1-4 carbon atoms, preferably methyl or ethyl radical, and
R⁹ is a difunctional alkyl radical having 2-10, preferably 2-6, carbon atoms,
   and R¹, R², and a are as defined for the general formula [2].

Preference is also given to alkoxysilanes (A) of the general formulae [6] and [7]

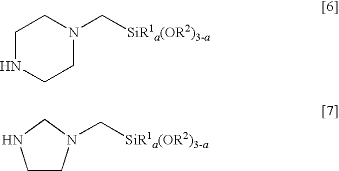

where R¹, R² and a are as defined for the general formula [2].

Preference is also given to alkoxysilanes (A) of the general formula [8]

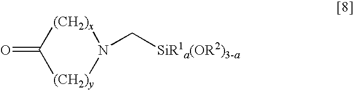

where
x and y are each integers from 0 to 4 and
R¹, R² and a are as defined for the general formula [2].

The silanes (A) are prepared preferably by the reaction of the corresponding α-halomethylalkoxysilanes, more preferably of the α-chloromethylalkoxysilanes, with secondary amines. The chlorine atom of the α-chlorosilane is substituted in this reaction by the respective secondary amine. This may take place either with or without catalyst; preferably, however, the reaction is carried out without a catalyst. The reaction may be carried out either in bulk or in a solvent. In that case the amine may serve simultaneously as an acid scavenger for the hydrogen halide released in the course of the nucleophilic substitution. Here, however, it is also possible to add another acid scavenger. In one preferred version of the silane preparation the silane is employed in excess.

The alkoxysilanes (A) of the general formula [5] that are employed with preference may in one particularly advantageous process be prepared by reacting a diamine of the general formula [9]

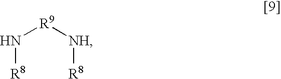

where R⁸ and R⁹ are as defined for the general formula [5], with the corresponding α-halomethylsilane.

In order to prepare the particularly preferred silanes of the general formulae [6] or [7] it is possible in the case of a corresponding reaction to start from piperazine or from tetrahydroimidazole, whereas for preparing the particularly preferred silanes of the general formula [8] compounds of the general formula [10] are used

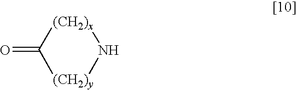

where x and y are as defined for the general formula [8].

The uses below of the silanes of the general formulae [2] to [8] can be carried out with the silane of the formula [1] or else without silane of the formula [1].

The silanes of the general formulae [2] to [8] are used preferably for the synthesis of silane-functional prepolymers (P). These prepolymers (P) are preferably prepared by subjecting the silanes of the general formulae [2] to [8]
a) to reaction with an isocyanate-terminated prepolymer (P1), or
b) to reaction with an NCO-containing precursor of the prepolymer (P), to form a precursor which contains silyl groups and which then, in further reaction steps, is reacted to form the completed prepolymer (P).

The proportions of the individual components are in this case preferably chosen such that all of the isocyanate groups present in the reaction mixture are consumed by reaction. The resulting prepolymers (P) are therefore preferably isocyanate-free.

As described, the silane-functional prepolymers (P) are able on contact with (atmospheric) moisture to cure, through the hydrolysis and condensation of the highly reactive alkoxysilyl groups of the silanes of the general formulae [2] to [8]. The polymers (P) can be employed for numerous different applications in the field of adhesives, sealants, and jointing compounds, surface coatings, and in connection with the production of moldings as well.

Another field of use for the silanes of the general formulae [2] to [8] is the modification of acrylates or epoxides. In such applications, monomeric, oligomeric or polymeric compounds having at least one acrylate function or epoxide function are reacted with the silanes of the general formulae [2] to [8], giving products which are able to cure as a result of the hydrolysis and condensation of the silane unit. In other words, the acrylate curing or epoxide curing of the system in question is replaced wholly or else only partly by silane curing. Particular preference is given in this context to the reaction of the silanes of the general formulae [2] to [8] with epoxy-functional compounds.

A further preferred field of use of the silanes of the general formulae [2] to [8] is the production of silane-modified particles (Pa), especially inorganic particles (Pa). For this purpose the silanes (A) are reacted with inorganic particles (Pa1).

Suitable particles (Pa1) include all metal oxide particles and mixed metal oxide particles (e.g., aluminum oxides such as corundum, mixed aluminum oxides of other metals and/or silicon, titanium oxides, zirconium oxides, iron oxides, etc.) or silicon oxide particles (e.g., colloidal silica, fumed silica, precipitated silica, silica sols). A further feature of the particles (Pa1) is that on their surface they possess functions selected from metal hydroxide (MeOH), silicon hydroxide (SiOH), Me-O-Me, Me-O—Si, Si—O—Si, Me-OR³, and Si—OR³, by which reaction may take place with the silanes of the general formulae [2] to [8]. The particles (Pa1) preferably possess an average diameter of less than 1000 nm, more preferably of less than 100 nm (the particle size being determined by means of transmission electron microscopy).

In one particularly preferred embodiment of the invention the particles (Pa1) are composed of fumed silica. In a further preferred version of the invention the particles (Pa1) used are colloidal silicon oxides or metal oxides which are present in general in the form of a dispersion of the corresponding oxide particles of submicron size in an aqueous or organic solvent. The oxides used may be, among others, those of the metals aluminum, titanium, zirconium, tantalum, tungsten, hafnium, and tin.

With regard to the functionalization of the particles (Pa1), the highly reactive alkoxysilyl functions of the silanes of the general formulae [2] to [8] react with the free MeOH or SiOH functions on the particle surface, eliminating an alcohol molecule (R²OH) in the process. Where monoalkoxysilanes, i.e., silanes of the general formulae [2] to [8] with a=2, are employed, the functionalization of the particles (Pa1) does not require the addition of water, which may possibly be particularly desirable. Where di- or trialkoxysilanes, i.e., silanes of the general formulae [2] to [8] with a=0 or 1, respectively, are used to functionalize the particles (Pa1), the hydrolysis and condensation of the alkoxysilyl groups of the silanes of the general formulae [2] to [8] are generally incomplete without addition of water. It is therefore necessary to add water if complete hydrolysis and condensation of the alkoxysilyl groups are desired.

The high reactivity of the silanes of the general formulae [2] to [8] make these compounds significantly more suited to the preparation of silane-modified particles (Pa) than conventional, prior-art silanes, which are significantly more tardy in their reaction. This is so particularly if particle modfication is carried out using the often particularly advantageous but usually less reactive monoalkoxysilanes, i.e., silanes of the general formulae [2] to [8] with a=2. The reactions of the particles (Pa1) with the highly reactive silanes of the general formulae [2] to [8] proceed rapidly and completely. As compared with other, likewise highly reactive prior-art α-amino-methylsilanes, the silanes of the general formulae [2] to [8] possess the advantage of a higher stability.

In the case of particle modification with the silanes of the general formulae [2] to [8], it is also possible to add catalysts. In that case it is possible to use all of the catalysts that are typically used for this purpose, such as organotin compounds, e.g., dibutyltin dilaurate, dioctyltin dilaurate, dibutyltin diacetyl-acetonate, dibutyltin diacetate or dibutyltin dioctoate, etc., organic titanates, e.g., titanium(IV) isopropoxide, iron(III) compounds, e.g., iron(III) acetylacetonate, or else amines, e.g., triethylamine, tributylamine, 1,4-diazabicyclo[2.2.2]octane, 1,8-diazabicyclo[5.4.0]undec-7-ene, 1,5-diazabicyclo[4.3.0]non-5-ene, N,N-bis(N,N-dimethyl-2-aminoethyl)methylamine, N,N-dimethylcyclohexylamine, N,N-dimethylphenylamine, N-ethylmorpholine, etc. Organic or inorganic Brönsted acids as well, such as acetic acid, trifluoroacetic acid, hydrochloric acid, phosphoric acid and its monoesters and/or diesters, such as butyl phosphate, (iso)propyl phosphate, dibutyl phosphate, etc., and acid chlorides such as benzoyl chloride, are suitable catalysts. Particular preference, however, is given to heavy-metal-free catalysts or to the complete absence of catalysts.

As a result of functionalizing the particles (Pa1) with the silanes of the general formulae [2] to [8], it is possible to obtain particles (Pa) having in some cases completely new properties. Thus it is possible to achieve considerable increases in qualities which include compatibility and dispersibility of the corresponding particles in an organic matrix. Moreover, by way of the reactive functions (F) introduced by the modification, the modified particles (Pa) can often be incorporated chemically as well into the corresponding matrix. Hence the inventively modified particles (Pa) can be used, among other applications, in organic polymers for the purpose of improving mechanical properties.

In a further preferred application the silanes of the general formulae [2] to [8] are reacted with silicone resins (H1) to give organosilane-modified silicone resins (H). Particular preference in this case is given to using silicone resins (H1) of the general formula [11]

(R¹⁰₃SiO_{1/2})ₑ(R¹⁰₂SiO_{2/2})_{f}(R¹⁰SiO_{3/2})_{g}(SiO_{4/2})ₕ [11]

where
R¹⁰ is a function OR¹¹, an OH function, an optionally halogen-, hydroxyl-, amino-, epoxy-, phosphonato-, thiol-, (meth)acryloyl-, or else NCO-substituted hydrocarbon radical having 1-18 carbon atoms, it being possible for the carbon chain to be interrupted by nonadjacent oxygen, sulfur or NR⁴ groups,
R¹¹ is an optionally substituted monovalent hydrocarbon radical having 1-18 carbon atoms,
e is a value greater than or equal to 0,
f is a value greater than or equal to 0,
g is a value greater than or equal to 0, and
h is a value greater than or equal to 0.

The modification of the silicone resins (H1) is also accomplished by reacting the highly reactive alkoxysilyl groups of the silanes of the general formulae [2] to [8] with free SiOH functions of the silicone resin (H1). In this context the silanes of the general formulae [2] to [8] have the same advantages over prior-art silanes as have already been described in connection with the functionalization of the purely inorganic particles (Pa1).

A further process for preparing the organosilane-modified silicone resins (H) may of course also be accomplished by incorporating the silanes of the general formulae [2] to [8] into the resin directly, by means of cocondensation, during the actual resin preparation. A further possibility for the synthesis of the silicone resins (H) is an equilibration reaction of resins (H1) with the silanes of the general formulae [2] to [8], and, if desired, water.

One of the possible uses of the silicone resins (H) modified with the silanes of the general formulae [2] to [8] is to modify the properties of organic polymers. A further preferred field of use of the silanes of the general formulae [2] to [8] is the preparation of organomodified silicone oils (S) through a reaction of the silanes of the general formulae [2] to [8] with OH-functional silicone oils (S1). The siloxanes (S1) may in this case be branched or unbranched. Particular preference, however, is given to using siloxanes (S1) of the general formula [12]

HO—[Si(R¹²)₂—O—]ₙ—H [12]

in which
R¹² is a hydrocarbon radical having 1 to 12 carbon atoms, preferably methyl radicals, and
n is a number from 1 to 3000, preferably a number from 10 to 1000.

The modification of the siloxanes (S1) is also accomplished by a reaction of the highly reactive alkoxysilyl groups of the silanes of the general formulae [2] to [8] with free SiOH functions of the siloxane (S1).

A further process for preparing the organosilane-modified siloxanes (S) can of course also be accomplished by incorporating the silanes of the general formulae [2] to [8] into the siloxane chain directly, by means of a cocondensation, during the actual siloxane preparation. A further possibility for the synthesis of the siloxanes (S) is an equilibration reaction of siloxanes (S1) with the silanes (A) and, if desired, water.

It is preferred here to use monoalkoxysilanes, i.e., silanes of the general formulae [2] to [8] with a=2. The advantage of the monoalkoxysilanes lies in the fact that in the course of a reaction with the siloxanes (S1) they are indeed able to provide the latter (S1) with organic functions, but that in doing so they exclusively terminate the chain ends of the siloxanes (S1), without any chain extension.

Likewise preferred is the use of a mixture of monoalkoxysilanes, i.e., silanes of the general formulae [2] to [8] with a=2, and dialkoxysilanes, i.e., silanes of the general formulae [2] to [8] with a=1. The former lead to a termination of the siloxane chain ends, while the latter lead to a chain extension. Through a suitable choice of the proportion of mono- and dialkoxysilanes and also the appropriate chain lengths of the siloxanes (S1) it is in this way possible to adjust as desired not only the average chain lengths but also the average degree of functionalization of the resulting organically modified siloxanes (S). In the case of the functionalization of the siloxanes (S1) the silanes of the general formulae [2] to [8] have the same advantages over the prior art as have already been described in connection with the fucntionalization of the particles (Pa1).

Particular preference is given here to using silanes of the general formulae [2] to [7] whose organic function (F) embraces an NH group. Amino-functional siloxanes (S) are obtained for which it is possible to indicate numerous different applications, as for example in textiles finishing, as for conventional amino-functional siloxanes, of the kind preparable from siloxanes (S1) and silanes in accordance with the prior art.

Furthermore, the amino-functional siloxanes (S) can also be reacted with further organic compounds to form copolymers which as well as the siloxanes also possess organic structural elements. Organic compounds used in this case are preferably difunctional monomeric, oligomeric or polymeric compounds.

Organic compounds used with particular preference are di- or polyisocyanates and also isocyanate-functional prepolymers. They react with the amino-functional siloxanes (S) to form copolymers which within their organic structural elements contain urea groups and also, possibly, additional urethane groups as well. Siloxane-urea copolymers of this kind are notable for particularly advantageous properties. For example, linear siloxane-urea copolymers at room temperature often possess elastomeric properties, as a result of the hydrogen bonds of the urea units and also, where present, urethane units. At higher temperatures, however, the hydrogen bonds collapse, so that the siloxane-urea copolymers can then be processed like conventional thermoplastic polymers.

As di- or polyisocyanates for preparing such siloxane-urea copolymers it is possible in principle to use all of the customary isocyanates of the kind widely described in the literature. Particular preference, however, is given to those diisocyanates with which the above-described linear copolymers are obtainable. Examples of customary diisocyanates include diiso-cyanatodiphenylmethane (MDI), tolylene diiso-cyanate (TDI), diisocyanatonaphthalene (NDI), isophorone diisocyanate (IPDI), perhydrogenated MDI (H-MDI) or else hexamethylene diisocyanate (HDI). If the UV stability of the siloxane-urea copolymers is important in the particular application, it is preferred to use aliphatic isocyanates.

Instead of the monomeric di- or polyisocyanates it is also possible to use oligomeric or polymeric isocyanate prepolymers as co-reactants for the amino-functional siloxanes (S). This gives copolymers having relatively large organic structural elements. The isocyanate prepolymers in this case are generally obtainable from di- or polyisocyanates and polyols, polyetherpolyols or polyesterpolyols for example, and also monomeric alcohols having at least two OH groups. The sequence of the reaction steps when preparing siloxane-urea-polyol copolymers of this kind is in principle arbitrary. In other words, it is also possible to react the amino-functional siloxanes (S) in a first reaction step with an excess of di- or polyisocyanates, and only in a second reaction step to react the excess isocyanate functions with a monomeric, oligomeric or polymeric diol or polyol or diamine or polyamine, respectively.

All of the above symbols in the above formulae have their definitions in each case independently of one another. In all formulae the silicon atom is tetravalent.

Unless indicated otherwise, all amounts and percentages are by weight, all pressures are 0.10 mPa (abs.), and all temperatures are 20° C.

### EXAMPLE 1

### Preparation of N-[(methyldiethoxysilyl)methyl]-piperazine

377 g (4.4 mol) of piperazine and 566 g of dioxane as solvent are charged to a 2 liter 4-neck flask and then rendered inert using nitrogen. This initial charge is heated at a temperature of 90° C. until the piperazine has fully dissolved. It is then cooled to 80° C. At this temperature 179.2 g (0.88 mol) of chloromethylmethyl-diethoxysilane are added dropwise over 2 h and the mixture is stirred at 80° C. for a further 2 hours. Following the addition of approximately ⅓ of the quantity of silane, the precipitation of the piperazine hydrochloride in salt form increases, but the suspension remains readily stirrable until the end of the reaction. The suspension is left to stand overnight. The precipitated salt is then filtered off and the solvent along with parts of the excess piperazine is removed by distillation at 60-70° C. The residue is cooled to 4° C., and the piperazine remaining in the reaction mixture precipitates. This precipitate is filtered off. The filtrate is purified by distillation (108-114° C. at 8 mbar). A yield of 123.4 g is achieved, i.e., about 60%, based on the quantity of silane employed.

### EXAMPLE 2

### Preparation of N-[(ethoxydimethylsilyl)methyl]-piperazine

482.0 g (5.6 mol) of piperazine and 723 g of dioxane as solvent are charged to a 2 liter 4-neck flask and then rendered inert using nitrogen. This initial charge is heated at a temperature of 90° C. until the piperazine has fully dissolved. It is then cooled to 80° C. At this temperature 155.3 g (1.12 mol) of chloromethyldimethyl-ethoxysilane are added dropwise over 2 h and the mixture is stirred at 80° C. for a further 2 hours. Following the addition of approximately ⅓ of the quantity of silane, the precipitation of the piperazine hydrochloride in salt form increases, but the suspension remains readily stirrable until the end of the reaction. The suspension is left to stand overnight. The precipitated salt is then filtered off and the solvent along with parts of the excess piperazine is removed by distillation at 60-70° C. The residue is cooled to 4° C., and the piperazine remaining in the reaction mixture precipitates. This precipitate is filtered off. The filtrate is purified by distillation (93° C. at 12 mbar). A yield of 109.4 g is achieved, i.e., 52%, based on the quantity of silane employed.

### EXAMPLE 3

### Preparation of N-[(triethoxysilyl)methyl]piperazine

905.3 g (10.5 mol) of piperazine and 945 ml of xylene (anhydrous) as solvent are charged to a 4 liter 4-neck flask and then rendered inert using nitrogen. This initial charge is heated at a temperature of 100° C., the piperazine fully dissolving. At this temperature 446.3 g (2.1 mol) of chloromethyltriethoxysilane are added dropwise within 1 h and the mixture is stirred for a further 15 min. Following the addition of approximately ⅓ of the quantity of silane, the precipitation of the piperazine hydrochloride in salt form increases, but the suspension remains readily stirrable until the end of the reaction. Subsequently the reaction mixture is heated to 110° C. and the precipitated salt is filtered off on a preheated filter.

The filtrate is cooled to approx. 5° C. and the piperazine excess that has precipitated at this temperature is filtered off. The solvent is then removed by distillation, with any residues of piperazine being removed likewise. The crude product thus obtained is purified by distillation (84-86° C. at 0.1 mbar). A yield is achieved of 357.5 g (1.36 mol), in other words about 65%, based on the quantity of silane employed.

### EXAMPLE 4

### Production of Amino-Functional Nanoparticles

30 g of IPA-ST (30.5% SiO₂ sol in isopropanol from Nissan Chemicals, 12 nm) are introduced at room temperature and admixed with 2.0 g of N-[(ethoxy-dimethylsilyl)methyl]piperazine, prepared as in example 2. The resulting mixture is stirred at 60° C. for 2 h and at room temperature for a further 15 h. This gives a largely clear dispersion which exhibits a slight Tyndall.

Via ¹H and ²⁹Si NMR spectroscopy, it is no longer possible to detect any free silane in this dispersion; in other words, the silane has all been consumed by reaction with the SiO₂ particles.

### EXAMPLE 5

### Production of Amino-Functional Silicone Oils

15.0 g (5.0 mmol) of a linear OH-terminated silicone oil having an average molar mass of approx. 3000 g/mol are admixed with 1.88 g (10.0 mmol) of N-[(ethoxy-dimethylsilyl)methyl]piperazine, prepared as in example 2. The mixture is stirred at room temperature for 15 h. Then the methanol formed is removed by distillation. ¹H and ¹³C NMR spectroscopy show complete conversion of the silane employed.

### EXAMPLE 6

### Production of an Alkoxysilyl-Functional Epoxy Resin

A solution of 2.5 g of an epoxy resin (Eponex® 1510: reaction product of hydrogenated bisphenol A and epichlorohydrin, EEW=210-220) in 2.5 ml of ethanol was admixed dropwise with 1.5 g of N-[(triethoxy-silyl)methyl]piperazine and the mixture was heated at 60° C. for 2 h with stirring. ¹H NMR spectroscopy indicated the complete reaction of the epoxide functions. The clear solution, of low viscosity, was poured into an aluminum tray for curing, and exhibited a skinning time of 2 min (22° C., 45% relative humidity). A smooth, clear, colorless layer was formed.

### EXAMPLE 7

### Determination of the Reactivity of α-Aminomethylsilanes and γ-Aminopropylsilanes with Respect to Moisture

The measure employed for the reactivity of the inventive and noninventive silanes was the skinning time of α,ω-alkoxysilyl-functional siloxanes. This was done by mixing a linear α,ω-hydroxy-functional siloxane (average molar mass: about 3000 g/mol) with 2.5 equivalents of the respective silane in a Speedmixer (DAV 150 FV from Hausschild) at 27 000 rpm for 20 s, pouring out the resulting oil, and determining the skinning time by contacting the surface with a spatula. The relative humidity was 32%. Skinning time of N-[(methyldiethoxysilyl)methyl]-piperazine (inventive): t<15 min Skinning time of γ-aminopropylmethyldiethoxysilane (noninventive): t>5 h

### EXAMPLE 8

### Determination of the Stability of α-Aminomethylsilanes in the Presence of Methanol

General instructions: The α-aminosilane is dissolved in methanol-D4 (10% by weight). The resulting solution is subjected to repeated measurement by ¹H NMR spectroscopy. The half-life (t_{1/2}) of the α-aminosilane is determined using the integrals of the methylene spacer ═N—CH₂—Si[(OR)R]₃ in the undecomposed α-aminosilane (δ about 2.2 ppm) and also the integral of the methyl group ═NCH₂D (δ about 2.4 ppm) that is obtained as a decomposition product (cleavage of the Si—C bond).

The silanes of the invention prepared in accordance with examples 1-3 still show no decomposition after 4 weeks. For comparison, the decomposition half-lives of certain prior-art α-aminomethylsilanes are shown:

Aminomethylmethyldimethoxysilane: t_{1/2}=6 h
Cyclohexylaminomethylmethyldimethoxysilane: t_{1/2}=1 week
Aminomethyltrimethoxysilane: t_{1/2}=19 h
Cyclohexylaminomethyltrimethoxysilane: t_{1/2}=3 days
Isobutylaminomethyltrimethoxysilane: t_{1/2}=1 week

1.-10. (canceled)

11. Alkoxysilanes (A) having the formula [4] 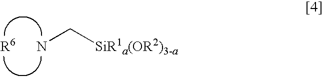
where
R¹ is an optionally substituted hydrocarbon radical or an ═N—CR³₂ group,
R² is a C₁₋₆ alkyl radical,
a is 0, 1, 2 or 3,
R⁴ is an optionally substituted alkyl, aryl or arylalkyl radical which possesses at least one carboxyl group, carbonyl group or one isocyanate-reactive OH, SH or NHR⁷ group, alkyl chains optionally interrupted by oxygen, carbonyl groups, sulfur or NR⁷ groups,
R⁶ is a difunctional, optionally substituted alkyl or arylalkyl radical, which possesses an isocyanate-reactive NH function or an NR⁴ function or is substituted by at least one isocyanate-reactive OH, SH or NHR⁷ group, the alkyl chain optionally interrupted by oxygen, sulfur or NR⁷ groups, and
R⁷ is hydrogen or an optionally substituted alkyl, aryl or arylalkyl radical,
where when 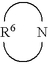
is a piperazinyl ring structure and a is 0, R² is selected from the group consisting of methyl and C₃₋₆ alkyl.

12. An alkoxysilane (A) of claim 11, wherein the radicals R¹ have 1 to 12 C atoms.

13. An alkoxysilane (A) of claim 11, which has one of the formulae [6] and [7]

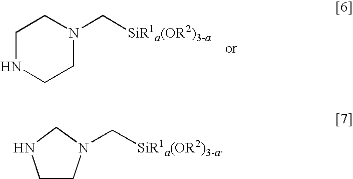

14. The alkoxysilane (A) of claim 11, wherein R² is methyl.

15. The alkoxysilane (A) of claim 14, wherein a is 0 or 1.

16. A process for synthesizing silane functional prepolymers, silane-modified acrylates, silane modified epoxides, silane-modified metal oxide or mixed metal oxide particles, silane-modified silicone resins, or silane-modified silicon oils, comprising reacting an alkoxysilane (A) of claim 11 with a substrate reactive therewith, selected from the group consisting of prepolymer precursors, acrylates, epoxides, metal oxide or mixed metal oxide particles, silicone resins, and silicone oils.

17. The process of claim 14, comprising reacting the alkoxysilane (A) with silica.

18. The process of claim 14, comprising reacting an alkoxysilane (A) having a primary or secondary amino group with an isocyanate-terminated prepolymer.
